(19) United States
(12) Patent Application Publication
(10) Pub. No.: US 2018/0361542 A1
(43) Pub. Date: Dec. 20, 2018

(54) Perpendicular Clamp System

(71) Applicant: Ray Dahl, Paso Robles, CA (US)

(72) Inventor: Ray Dahl, Paso Robles, CA (US)

(21) Appl. No.: 15/625,047

(22) Filed: Jun. 16, 2017

(51) Int. Cl. B25B 7/02; B25B 7/12

(52) U.S. Cl. CPC B25B 7/02; B25B 7/123

(57) ABSTRACT

A perpendicular clamp system includes a pair of pliers that are selectively manipulated to clamp an object or objects. The pliers are selectively positioned in an open position and a closed position. A tensioner is movably coupled between the pliers to adjust a clamping pressure of the pliers between a minimum pressure and a maximum pressure. A pair of jaws is provided and each of the jaws is coupled to the pliers. The jaws are oriented perpendicular to the pliers to clamp an object having the pliers being oriented perpendicular to the object.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to clamp devices and more particularly pertains to a new clamp device for clamping an object having the clamp being perpendicularly oriented with respect to the object.

### BRIEF SUMMARY OF THE INVENTION

An embodiment of the disclosure meets the needs presented above by generally comprising a pair of pliers that are selectively manipulated to clamp an object or objects. The pliers are selectively positioned in an open position and a closed position. A tensioner is movably coupled between the pliers to adjust a clamping pressure of the pliers between a minimum pressure and a maximum pressure. A pair of jaws is provided and each of the jaws is coupled to the pliers. The jaws are oriented perpendicular to the pliers to clamp an object having the pliers being oriented perpendicular to the object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a perpendicular clamp system according to an embodiment of the disclosure.

FIG. 2 is a bottom view of an embodiment of the disclosure.

FIG. 3 is a front view of an embodiment of the disclosure.

FIG. 4 is an exploded view of an embodiment of the disclosure.

FIG. 5 is an in-use view of an embodiment of the disclosure.

### DETAILED DESCRIPTION OF THE INVENTION

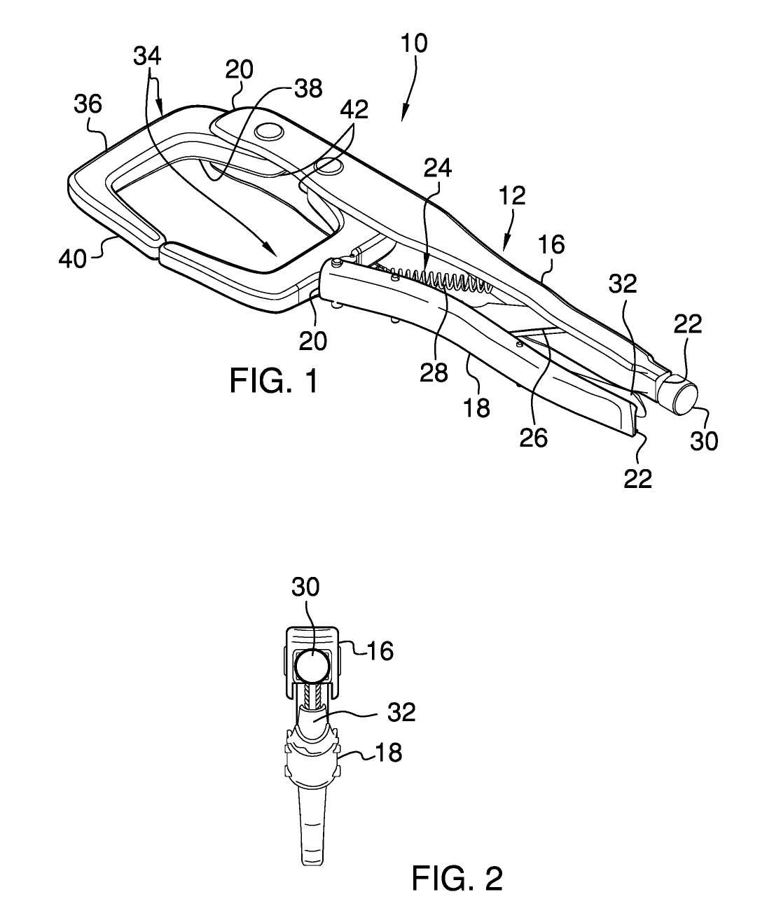

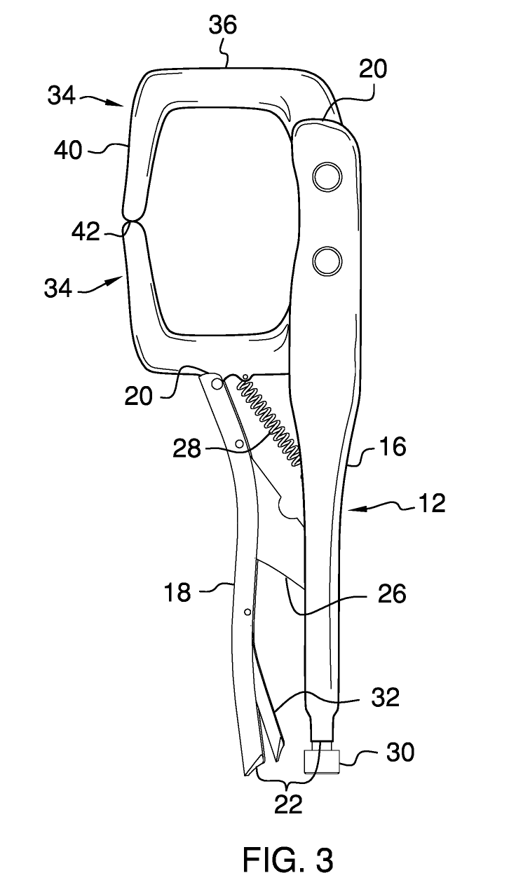

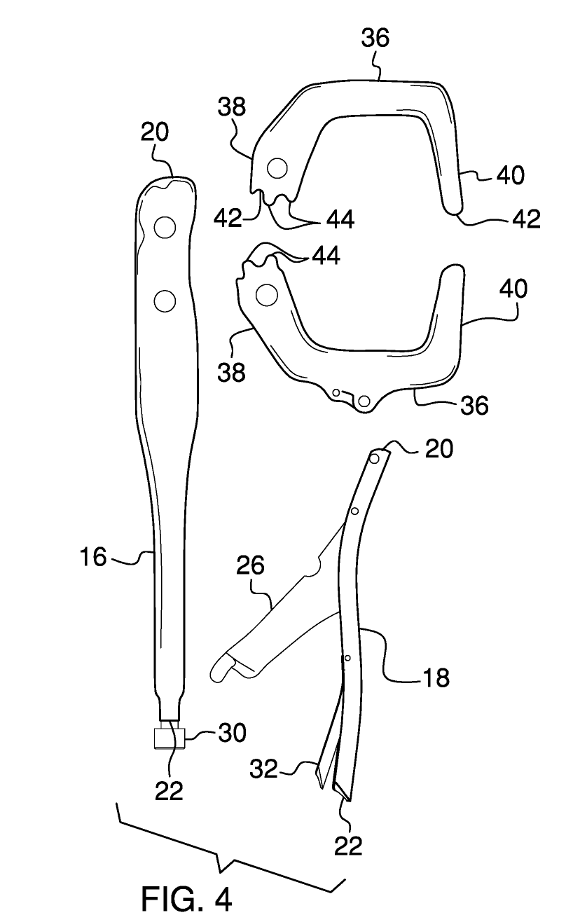

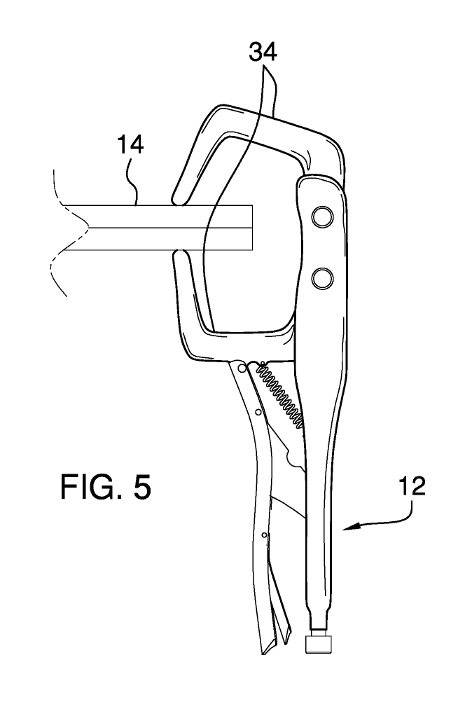

With reference now to the drawings, and in particular to FIGS. 1 through 5 thereof, a new clamp device embodying the principles and concepts of an embodiment of the disclosure and generally designated by the reference numeral 10 will be described.

As best illustrated in FIGS. 1 through 5, the perpendicular clamp system 10 generally comprises a pair of pliers 12 that are selectively manipulated for clamping an object 14 or objects 14. The pair of pliers 12 includes a first handle 16 that is movably coupled to a second handle 18. Each of the first 16 and second 18 handles has a first end 20 and a second end 22, and the pliers 12 are selectively positioned in an open position and a closed position. The pliers 12 may be Vice Grip pliers manufactured by Irwin Tools, 8935 Northpoint Executive Drive, Huntersville, N.C. 28078. The first handle 16 may have a length ranging between approximately 25.0 cm and 30.0 cm. The second handle 18 may have a length ranging between approximately 15.0 cm and 20.0 cm.

A tensioner 24 is movably coupled between the pliers 12 to adjust a clamping pressure of the pliers 12 between a minimum pressure and a maximum pressure. The tensioner 24 may include a hinge 26 extending between the first 16 and second 18 handles, a biasing member 28 extending between the first 16 and second 18 handles and a screw 30 being movably coupled to the first handle 16. The screw 30 may be manipulated to adjust the clamping pressure and a lever 32 may be movably coupled to the second handle 18. The lever 32 may be manipulated to urge the pliers 12 into the open position.

A pair of jaws 34 is provided and each of the jaws 34 is coupled to the pliers 12. The jaws 34 are oriented perpendicular to the pliers 12 to clamp the object 14 having the pliers 12 being oriented perpendicular to the object 14. The object 14 may be a table top, a pair of panels or any other object 14. Additionally, the pliers 12 are selectively positioned to extend upwardly and downwardly from the object 14 when the object 14 is clamped. In this way the pliers 12 are inhibited from poking a user when the user is standing next to the object 14.

Each of the jaws 34 has a central member 36 extending between a first member 38 and a second member 40 such that each of said jaws 34 has a U-shape. Each of the first 38 and second 40 members has a distal end 42 with respect to the central member 36. Moreover, the distal end 42 of the first member 38 corresponding to each of the jaws 34 members is pivotally coupled to the first end 20 of the first handle 16. The first end 20 of the second handle 18 is pivotally coupled to the central member 36 of an associated one of the jaws 34. The central member 36 corresponding to each of the jaws 34 is oriented perpendicular to an axis extending through the first 20 and second 22 ends of the pliers 12.

The second handle 18 is urged away from the first handle 16 to position the pliers 12 in the open position. Additionally, the second handle 18 is selectively urged downwardly to pivot the associated jaw 34 downwardly on the first handle 16. The distal end 42 of the first member 38 corresponding to each of the jaws 34 has a plurality of teeth 44 extending outwardly therefrom. The teeth 44 on the first member 38 corresponding to each of the jaws 34 engage each other. In this way the pair of jaws 34 is urged to pivot away from each other when the second handle 18 is urged downwardly. Thus, the distal end 42 of the second member 40 corresponding to each of the jaws 34 is spaced apart from each other when the pliers 12 are positioned in the open position. Additionally, the distal end 42 of the second member 40 corresponding to each of the jaws 34 is urged toward each other when the pliers 12 are positioned in the closed position.

In use, the pliers 12 are manipulated to position the object 14 between the jaws 34 and the pliers 12 are manipulated into the closed position to clamp the object 14. Each of the first 16 and second 18 handles is oriented to selectively extend upwardly and downwardly from the object 14 when the jaws 34 clamp the object 14. In this way the first 16 and second 18 handles are inhibited from poking the user when the object 14 is positioned on a drill press, a table saw, a table top or any other machinery thereby enhancing the user's access to the object 14. Additionally, the perpendicular orientation of the pliers 12 facilitates the object 14 to be clamped in an area with limited clearance.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

Amendments in the claims: (struck-through parts deleted and underlined parts added):

1. A perpendicular clamp system being configured to urge clamp an object at a right angle, said system comprising:
a pair of pliers being configured to be manipulated, said pliers being selectively positioned in an open position and a closed position, each of said pair of pliers being substantially elongated and oriented substantially parallel such that said pair of pliers extend in common along a first direction;
a tensioner being movably coupled between said pliers such that said tensioner adjusts a clamping pressure of said pliers between a minimum pressure and a maximum pressure; and
a pair of jaws, each of said jaws being coupled to said pliers, said jaws being oriented to extend from said pair of pliers perpendicular to said first direction wherein said jaws extend laterally from said pair of pliers, said jaws closing in a clamping motion substantially parallel to said first direction wherein said jaws are configured to clamp opposing faces of a planar object having said first direction being oriented perpendicular to the substantially planar object.

2. The system according to claim 1, wherein each of said jaws has a central member extending between a first member and a second member, each of said first and second members having a distal end with respect to said central member.

3. The system according to claim 2, wherein:
said pair of pliers includes a first handle being movably coupled to a second handle, each of said first and second handles having a first end and a second end; and
said distal end of said first member corresponding to each of said jaws members being pivotally coupled to said first handle of said pliers having said central member corresponding to each of said jaws being oriented perpendicular to an axis extending through said first and second ends of said pliers.

4. The system according to claim 2, wherein said distal end of said second member corresponding to each of said jaws are spaced apart from each other when said pliers are positioned in said open position, said distal end of said second member corresponding to each of said jaws being urged toward each other when said pliers are positioned in said closed position.

5. A perpendicular clamp system being configured to urge clamp an object at a right angle, said system comprising:
a pair of pliers being configured to be manipulated, said pair of pliers including a first handle being movably coupled to a second handle, each of said first and second handles having a first end and a second end, said pliers being selectively positioned in an open position and a closed position, each of said pair of pliers being substantially elongated and oriented substantially parallel such that said pair of pliers extend in common along a first direction;
a tensioner being movably coupled between said pliers such that said tensioner adjusts a clamping pressure of said pliers between a minimum pressure and a maximum pressure; and
a pair of jaws, each of said jaws being coupled to said pliers, said jaws being oriented to extend from said pair of pliers perpendicular to said first direction pliers wherein said jaws extend laterally from said pair of pliers, said jaws closing in a clamping motion substantially parallel to said first direction wherein said jaws are configured to clamp opposing faces of a planar object having said first direction being oriented perpendicular to the substantially planar object, each of said jaws having a central member extending between a first member and a second member, each of said first and second members having a distal end with respect to said central member, said distal end of said first member corresponding to each of said jaws members being pivotally coupled to said first handle of said pliers having said central member corresponding to each of said jaws being oriented perpendicular to an axis extending through said first and second ends of said pliers, said distal end of said second member corresponding to each of said jaws being spaced apart from each other when said pliers are positioned in said open position, said distal end of said second member corresponding to each of said jaws being urged toward each other when said pliers are positioned in said closed position.
